(19) United States
(12) Patent Application Publication
(10) Pub. No.: US 2014/0252997 A1
(43) Pub. Date: Sep. 11, 2014

(54) SECURE METHOD OF CUTTING OFF THE POWER SUPPLY OF AN ELECTRIC MOTOR AND CORRESPONDING DEVICE

(71) Applicants: COMPAGNIE GENERALE DES ETABLISSEMENTS MICHELIN, ELERMONT-FERRAND (FR); Michelin Recherche et Technique S.A., GRANGES-PACCOT (CH)

(72) Inventors: Patrice Cavin, Corcelles-Payerne (CH); Ruben André Nunes Espirito Santo, Avenches (CH); Pierre-Alain Magne, Delley (CH)

(21) Appl. No.: 14/350,504

(22) PCT Filed: Oct. 11, 2012
(86) PCT No.: PCT/EP2012/070202

§ 371 Date: Apr. 8, 2014

(30) Foreign Application Priority Data
Oct. 11, 2011 (FR) 1159148

(51) Int. Cl. H02P 3/18; B60L 11/18

(52) U.S. Cl. CPC H02P 3/18; B60L 11/1803
USPC 318/139; 307/10.1

(57) ABSTRACT

A device is provided for controlling and supplying power to a multi-phase electric motor powered by a main battery. The device includes an electronic power module, a drive module, and a monitoring unit. The electronic power module supplies power from the main battery to phases of the motor. The drive module supplies electric drive signals to transistors of the electronic power module. The monitoring unit supplies drive instructions, which define chopping ratios of the transistors of the electronic power module, to the drive module. The drive module is electrically powered by a connector that includes a relay capable of instantaneously interrupting supply of power to the drive module, in order to stop the motor, without interrupting supply of power to the monitoring unit.

The object of the invention is a secure device for controlling and supplying power to an electric motor powered by an electronic power module, in particular an electric motor of a motor vehicle. A more particular object of the invention is to enable a secure method of interrupting the supply of power to the motor. This is imperative from a safety viewpoint in the case of an electric vehicle in order to guarantee never producing a driving torque inconsistent with the wishes of the driver.

For example, in the case of a vehicle equipped with a central electric motor, motor torque must not be generated when one is stopped at a pedestrian crossing. As soon as a malfunction is detected, it is necessary to react very quickly and place the motor (or motors) in a safe state. In the case of a driving motor, placing in a safe state consists of cutting off the drive so as to generate no torque through the motor, namely neither motor torque nor braking torque.

In the case of a vehicle with two independent driving wheels on the same axle, the above is equally valid. It is all the more necessary to intervene rapidly and in a safe manner to place the two motors in a secure withdrawal mode (in the case of driving motors, this mode is cutting off drive) because it is necessary to avoid, in the event of a malfunction, the application of different torques between the two wheels, which would make it difficult to hold the desired trajectory.

The invention can just as well be applied to an electric motor used to propel the vehicle as to other electric motors, for example, electric suspension motors.

The invention can also be applied to any electric motor powered by an electronic power module, beyond the motor vehicle application.

Electric motors capable of propelling a vehicle are powered by an electrical energy source on-board the vehicle. One solution for the energy source can be, for example, high capacity, high voltage batteries. Another solution can be a fuel cell supplied with hydrogen or any other energy source producing electricity, or any system combining different energy sources. In the following, the generic term “main battery” will be used to make reference to the electrical energy source.

The main battery and the motor are therefore generally isolated from the vehicle chassis for safety reasons.

The control module enabling the driver's wishes to be transmitted to the power device supplying power to the motor is generally built into an electronic assembly, which in turn is powered by an auxiliary battery, generally of a lower voltage, one of the terminals of which is referenced to the vehicle chassis.

For reasons of functioning safety, it is important to guarantee that the electric motor acts correctly vis-à-vis the driver's wishes. If it were found that this is not the case and that the electronic drive and motor assembly is in a malfunctioning situation, it is necessary, in order to be able instantaneously to cut off the drive to the motor in an emergency, to be able to interrupt the supply of power to the phases of the motor in the most reliable way possible.

To do this, one can consider interrupting the circuit supplying power from the main battery powering the motor, or consider interrupting the control chain of the electronic system connected to the auxiliary battery.

The aim of the invention is to propose a device for controlling and supplying power to an electric motor that will allow an emergency stop of the motor at the driver's request, or further to the detection of a malfunction in the drive chain of the power device.

This system must guarantee optimum safety so that no phase of the motor continues to be supplied with power after the cut-off—due for example to components that would continue to function independently or inadvertently. This system must take account of the constraints of isolating the motor and main battery assembly, and must present a simple architecture both for reasons of costs and reliability.

For this purpose, a device for controlling and supplying power to a multi-phase electric motor powered by a first battery called main battery includes an electronic power module supplying power from the main battery to the phases of the motor, a drive module supplying electric drive signals to the transistors of the electronic power module, and a monitoring unit supplying drive instructions, defining the chopping ratios of the transistors of the electronic power module, to the drive module. The drive module is powered by a connection including a relay capable of instantaneously interrupting the supply of power to the drive module with a view to stopping the motor without interrupting the supply of power to the monitoring unit.

In other words, the relay is capable of totally cutting off the supply of energy to the drive module without interrupting the supply of power to the monitoring unit.

Advantageously, the drive module and the monitoring unit are capable of being powered by a second voltage battery called auxiliary battery, the relay allowing the supply of power to the drive module to be interrupted from this second battery.

The relay can be connected such that it can be controlled from a manual control switch.

According to a preferred embodiment, the monitoring unit is connected to the relay and is configured to open the relay when a self-test procedure detects faulty functioning of the monitoring unit.

The monitoring unit can be connected to a supervisory system capable of detecting an excessive occupation rate of the monitoring unit, said supervisory system in turn being connected to the relay and being configured to open the relay when the response time of the monitoring unit exceeds a certain threshold.

In a preferred manner, the drive module is electrically isolated from the electronic power module.

In a preferred embodiment, the monitoring unit is configured to remain live when the relay opens.

The electronic power module is preferably configured to remain connected to the main battery when the relay opens.

According to a possible embodiment, a single monitoring unit is configured to drive two distinct drive modules, each dedicated to an electric motor. A common relay can then enable the interruption of the supply of power to the two drive modules. According to a variant of this embodiment, two relays for interrupting the supply of power can be dedicated respectively to each of the two drive modules.

According to another aspect, the invention relates to a motor vehicle the driving wheels of which are driven by an electric motor supplied with power by a device such as described earlier.

The vehicle can incorporate at least two driving wheels, each equipped with an electric motor supplied with power by a device such as described earlier.

According to a possible embodiment, two motors of a same vehicle can be supplied with power jointly by a device such as described above.

According to another aspect, the invention relates to a method of controlling and supplying power to a multi-phase electric motor powered by a main battery in which, in order to obtain an emergency stop of the motor, the supply of power is maintained to a monitoring unit capable of defining the chopping ratios of the electronic power module associated with the motor and a supply of power is interrupted to a drive module, which is controlled by the monitoring unit and which is capable of supplying control signals to the transistors of the electronic power module.

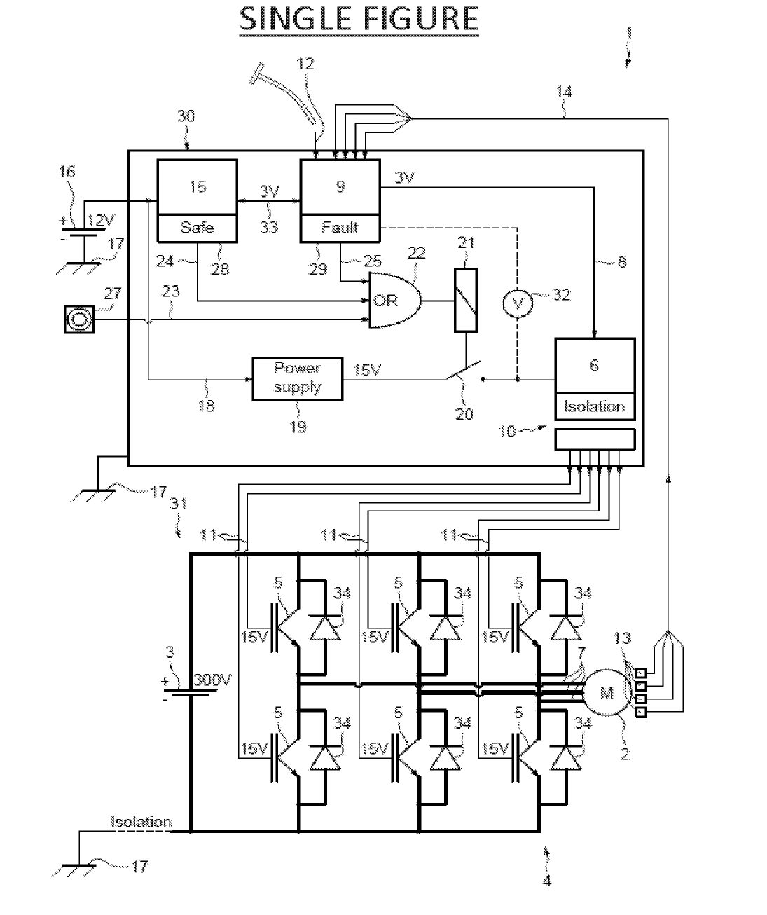

Further aims, characteristics and advantages of the invention will emerge from reading the following description, given only as a non-restrictive example, and made with reference to FIG. 1 attached, representing in a diagrammatic manner a device for controlling and supplying power according to the invention.

As illustrated on FIG. 1, a device 1 for controlling and supplying power includes a motor power supply unit 31 isolated from the chassis 17 of the vehicle. The motor power supply unit 31 powers a three-phase electric motor 2. The motor power supply unit 31 includes a main battery 3, which powers the motor 2 through an electronic power module 4. The motor 2 can, for example, actuate the two driving wheels (not represented) of a vehicle through a transmission system (not represented) equipped with a differential gear. According to the embodiment variants, the motor 2 can actuate a single one of the driving wheels of a vehicle, or be dedicated to another function, for example, the suspension of a vehicle.

The main battery 3 is a battery with sufficient power to ensure the propulsion of the vehicle and provides a relatively high voltage, typically a voltage between 150 and 450 volts. The electronic power module 4 includes an electric network in which pairs of transistors 5 and diodes 34 are inserted in such a way that the direct current supplied by the main battery 3 can be transformed to three-phase currents arriving at the three phases 7 of the motor 2. Each transistor is associated with a diode installed in parallel with the transistor. All of the voltages indicated on FIG. 1 are given only as examples, in order to give an idea of the voltage domains within which the different parts of the device 1 function.

The transistors 5 can typically be six in number, and can be of the IGBT (Insulated Gate Bipolar Transistor) type often used for this type of electronic power module. The transistors could also be transistors of another type, for example, MOSFET transistors.

The device 1 for controlling and supplying power also includes an electronic monitoring assembly 30 referenced to the chassis 17 and powered by an auxiliary battery 16 having a reduced voltage, for example, with a voltage of the order of twelve volts. One of the terminals of the auxiliary battery 16 is therefore connected to the chassis 17. The electric monitoring assembly 30 notably includes the auxiliary battery 16, a supervisory system 15, an electronic monitoring unit 9, a drive module 6 and an interrupting relay 20.

The drive module 6 supplies, through an isolation interface 10, electric signals transiting through connections 11 connecting the isolation interface 10 and the transistors 5. The electric signals supplied through the connections 11 allow the transistors 5 to be made conducting or blocked.

The isolation interface 10 can, for example, consist of a system of transformers, the drive module 6 supplying, on primary coils of a series of transformers (not represented), signals, which will be transmitted by magnetic induction into the connections 11 connected to the secondary coils of the series of transformers.

The isolation interface 10 enables the safety of passengers to be ensured by isolating the chassis of the vehicle from the vehicle high voltage network originating from the main battery 3. This is a safety principle, which, in the event of contact, accidental or not, of a person with a live part of the high voltage circuit, prevents said person, referenced to earth (that is to say to the vehicle chassis), from being electrocuted.

The drive module 6, in order to be able to generate signals having sufficient energy to activate the transistors 5, is supplied with power from the auxiliary battery 16 through a controlled power supply 19.

The controlled power supply 19 enables, for example, the drive module 6 to be supplied with a constant voltage, even when the voltage at the terminals of the auxiliary battery 16 varies with the charged state of the auxiliary battery.

The supply voltage to the drive module 6 is thus, for example, of the order of 15 volts, and the voltage of the signals sent by the connections 11 is of the same order, for example, also of the order of maximum 15 volts.

One can imagine embodiment variants where the drive module 6 is capable of being supplied with power by a variable voltage power supply and is supplied with power directly from the auxiliary battery 16 without passing through an intermediate controlled power supply 19.

The time sequencing of the signals supplied by the drive module 6 is defined by a monitoring unit 9, which transmits, in the form of electronic signals, through a connection or a series of connections 8, an instruction motif, which the drive module 6 retranscribes as signals of sufficient amplitude to activate the transistors 5.

The voltage and current amplitudes transiting through the connection or connections 8 correspond to amplitudes of microelectronic programming signals, for example, voltages of the order of three to five volts.

The monitoring unit 9 calculates the cyclic chopping ratios that must be imposed upon the transistors 5 depending on the torque one wishes to obtain from the motor 2.

The monitoring unit 9 receives, for this purpose, signals arriving through a connection 12, for example, from an accelerator pedal installed on board the vehicle and translating the driver's wishes in terms of acceleration of the vehicle. The monitoring unit 9 receives, also through a connection bus 14, information arriving from a series of sensors 13, for example, a sensor of the rotor position, a motor temperature sensor. The monitoring unit 9 also receives information from sensors of the current of the motor phases.

Depending on the present functioning point of the motor and on the driver's instructions, the monitoring unit 9 determines a desired functioning point of the motor and calculates the cyclic chopping ratio of the different transistors 5, which is required to obtain this functioning point. It then transmits the diagram of this cyclic chopping ratio to the drive module 6.

The monitoring unit 9 is supplied in turn with current stabilized by a supervisory and controlled power supply system 15, often designated by the acronym SBC (System Basis Chip).

The supervisory and power supply system 15 supplies the monitoring unit 9 with power from the auxiliary battery 16, providing the monitoring unit 9 with a sufficiently stable power supply voltage, typically a power supply stabilized at 3.3 volts.

The supervisory system 15 is furthermore capable of detecting an excessive occupation rate of the monitoring unit 9. For this, the supervisory system 15 sends requests to the monitoring unit 9 and verifies that the responses are correct and that the response time to these requests does not exceed a certain threshold. If the response time exceeds a certain threshold, this could reflect an excessive occupation rate of the computers of the monitoring unit 9; such an excessive occupation rate risks resulting in errors of calculation or automatic control.

The supervisory system 15, if it detects such an excessive occupation rate, is then capable of performing a reset to zero of the monitoring unit 9.

In order to be able to stop the drive to the motor in an emergency, a relay 20 is installed on the connection 18 enabling the drive module 6 to be supplied with power from the auxiliary battery 16. In the embodiment represented on the figure, the relay 20 is activated by its magnetic coil 21. The coil 21 is connected to a logic gate 22, which supplies, for example, an opening signal to the relay 20 at the coil 21 if at least one among a series of connections 23, 24, 25 arriving at the logic gate 22 sends a logic signal equal to 1. Depending on the embodiment variants, one can certainly decide on the contrary that the relay 20 must open if one of the signals arriving at the logic gate is equal to zero.

The connections arriving at the logic gate 22 include connections 23, 24, 25 respectively connecting the logic gate 22 to a manual switch 27, to the supervisory system 15, to the monitoring unit 9 and possibly to other calculation units (not represented).

By means of the connection 23, the relay 20 can be opened when the driver or another person intervening on the vehicle operates a manual switch 27. The switch 27 can be situated, for example, on the dashboard.

The connection 24 is connected to an overload test unit for the monitoring and supervisory unit of the power supplies 28 built into the supervisory system 15, which sends a signal equal to 1 if the supervisory system 15 detects an excessive occupation rate of the monitoring unit 9 or a non-conforming voltage.

The connection 25 is connected to a self-test unit 29 of the monitoring unit 9, which performs continuous tests checking the proper functioning of the monitoring unit 9 (clock, ADC converter etc). If the self-test unit 29 detects a malfunction of the monitoring unit 9, it sends a signal equal to 1 through the connection 25.

Additional conditions for emergency stopping of the motor can certainly be defined, either at the level of the tests performed by the supervisory system 15, or at the level of the tests performed by the monitoring unit 9.

The relay 20 is described here as a mechanical relay, but could certainly be replaced by any means enabling the interruption of the supply of power to the drive module 6, for example, a static switch of the transistor type. The relay 20 can also be built into the controlled power supply 19, either as a relay, or as a command making it possible to cut off the power supply 19. The power supply 19 can be a power supply controlled by a command. The output of the logic gate 22 can then be connected to the controlled power supply 19 so as to invalidate the supply of power, that is to say, to give the order no longer to supply power to the drive module 6, if at least one among the connections 23, 24, 25 arriving at the logic gate 22 sends a logic signal equal to 1.

A voltmeter 32 can be connected to the monitoring unit 9 so as to measure a monitoring voltage, between, for example, downstream of the relay 20 (downstream in relation to the auxiliary battery 16) and the chassis 17 of the vehicle, so as, firstly, to make sure that the desired withdrawal mode (that is to say, motor drive cut off) is actually effective, and secondly, (if necessary) to test for correct functioning of this cut-off during the initialization phase of the electronics.

The monitoring unit 9 can thus be informed that the relay 20 has been opened. The relay 20 is technically fairly easy to embody, as it interrupts a line of moderate voltage and it is not necessary to isolate it from the vehicle chassis.

If one were to choose, for example, to prohibit the supply of power to the motor by opening the connections 11, which are also low voltage connections, it would be necessary to provide one relay per connection—or a multiple relay capable of opening all the connections at the same time. It would certainly be conceivable to provide a cut-off relay directly on the power supply phases of the motor 2, or between the main battery 3 and the electronic power module 4. However, such a relay or such a group of relays would be subjected both to the constraint of having to resist very significant powers and voltages (voltages of the order of 150 to 400 volts, intensity capable of going, for example, up to 300 or 400 amperes), and to the constraint of having to be provided with a control isolated in relation to the chassis 17. A relay incorporates, by its construction, insulation between its coil and its contact. If the relay is installed in the high voltage zone, this relay must be capable of functioning under the voltage from the main battery and the quality of the insulation between the coil and the contact must be compatible with the voltage level of the main battery.

Conversely, a relay that would be placed directly at the terminals of the auxiliary battery 16, or a relay that would come to interrupt the power supply connection 33 of the monitoring unit 9 is neither subjected to insulation constraints, nor needs to resist a high voltage.

However, at the same time as it provokes a stop of the signals enabling the supply of power to the phases of the motor, the opening of such a relay also provokes a stop of the monitoring unit 9. One therefore loses, at the same time as one stops the motor, a whole flow of information which can make it possible to assist in mastering the vehicle, for example, by powering the braking strategy or by powering the process of an immediate restart of the motor 2 if the motor stop does not need to be prolonged.

Furthermore, it can happen that the drive module 6, which would continue to be supplied with power through the connection 18, but would not receive any instruction signals through the connection 8, races, and that it continues to deliver signals to the transistors 5 in spite of the absence of instruction emanating from the monitoring unit 9.

The desired emergency stop of the motor could therefore not be obtained or could be obtained with a delay. Conversely, by cutting off the supply of power to the drive module 6, the latter does not have sufficient energy to generate command signals for the transistors 5.

In the absence of command signals, the transistors 5 will therefore remain in the blocked position, and as the diodes 34 associated with each transistor are installed in the non-passing direction in relation to the terminals of the main battery 3, no current will be able to transit towards the phases 7 of the motor 2.

The object of the invention is not limited to the described embodiment, and can be declined into numerous variants. For example, in the case of a vehicle equipped with two driving wheels each actuated by a dedicated motor, one can envisage that the system may be duplicated for each driving wheel. One can also envisage that the system may be only partially duplicated, with a same supervisory system 15 and a same monitoring unit 9 making it possible to send chopping ratio instructions to two distinct drive modules 6. Each drive module 6 can then be equipped with a dedicated relay 20 distinct from that of the other drive module, and enabling one or other of the motors to be stopped independently.

The system described in FIG. 1 can in turn allow several motors to be controlled simultaneously if the drive module 6 supplies a number of output signals corresponding to the number of transistors of the electronic power modules 4 associated with the different motors. In this case, the activation of the relay 20 allows all the motors thus controlled to be stopped simultaneously.

The device for controlling and supplying power according to the invention makes it possible to ensure an immediate cutting off of the motor in an emergency by means of a low voltage relay, one of the terminals of which can if necessary be connected to the vehicle chassis. Controlling the setting to the withdrawal mode, that is to say the effective cutting off of the motor, is also simple to embody, since it suffices to verify a voltage between the chassis and a power supply point of the drive module.

The main battery is not necessarily a high voltage source between 150V and 450V. It can be a source of higher voltage or lower voltage, and even the same source as that of the auxiliary battery.

In the case of a low voltage battery (lower than 60V for example), it is not always necessary to resort to isolation between the battery part and the chassis. In this type of configuration, the drive module according to the invention does not need to be a module isolated from the chassis.

In the case of a relatively low power source voltage (of the order of 60V), one can imagine having only a single source for the power network and for the auxiliary network.

The device according to the invention can be of particular value in the case of an electric vehicle having several driving wheels operated by independent motors. The system then allows either one or the other motor to be cut off independently, or the two motors to be reliably cut off simultaneously, so as to avoid a loss of stability linked with the erratic functioning of a single one of the motors, and thus to avoid different torques between the wheels.

1-15. (canceled)

16. A device for controlling and supplying power to a multi-phase electric motor powered by a main battery, the device comprising:
an electronic power module, which supplies power from the main battery to phases of the motor;
a drive module, which supplies electric drive signals to transistors of the electronic power module; and
a monitoring unit, which supplies drive instructions to the drive module,
wherein the drive instructions define chopping ratios of the transistors of the electronic power module, and
wherein the drive module is powered by a connector that includes a relay capable of instantaneously interrupting a supply of power to the drive module, in order to stop the motor, without interrupting a supply of power to the monitoring unit.

17. The device according to claim 16,
wherein the drive module and the monitoring unit are capable of being powered by an auxiliary battery having a lower voltage than a voltage of the main battery, and
wherein the relay is capable of interrupting the supply of power to the drive module from the auxiliary battery.

18. The device according to claim 16, wherein the relay is capable of being controlled from a manual control switch.

19. The device according to claim 16, wherein the monitoring unit is connected to the relay and is configured to open the relay when a self-test procedure detects faulty functioning of the monitoring unit.

20. The device according to claim 16,
wherein the monitoring unit is connected to a supervisory system capable of detecting an excessive occupation rate of the monitoring unit, and
wherein the supervisory system is connected to the relay and configured to open the relay when a response time of the monitoring unit exceeds a predetermined threshold.

21. The device according claim 16, wherein the drive module is electrically isolated from the electronic power module.

22. The device according to claim 16, wherein the monitoring unit is configured to remain live when the relay opens.

23. The device according to claim 16, wherein the electronic power module is configured to remain connected to the main battery when the relay opens.

24. The device according to claim 16, wherein the monitoring unit is a single unit configured to drive two distinct drive modules, each drive module being dedicated to an electric motor.

25. The device according to claim 24, wherein the relay is a common relay for interrupting a supply of power to the two distinct drive modules.

26. The device according to claim 24, further comprising a second relay, wherein each of the relay and the second relay are configured to interrupt a supply of power and are dedicated to a respective one of the two distinct drive modules.

27. A motor vehicle comprising:
an electric motor;
a plurality of driving wheels that are driven by the motor; and
a device for controlling and supplying power to the motor, wherein the device includes:
an electronic power module, which supplies power from a main battery to phases of the motor,
a drive module, which supplies electric drive signals to transistors of the electronic power module, and
a monitoring unit, which supplies drive instructions to the drive module,
wherein the drive instructions define chopping ratios of the transistors of the electronic power module, and
wherein the drive module is powered by a connector that includes a relay capable of instantaneously interrupting a supply of power to the drive module, in order to stop the motor, without interrupting a supply of power to the monitoring unit.

28. A motor vehicle, comprising:
a plurality of electric motors;
a plurality of driving wheels, each of the driving wheels being equipped with a respective one of the motors; and
a plurality of devices, each of the devices being configured to control and supply power to a respective one of the motors,
wherein each of the devices includes:
an electronic power module, which supplies power from a main battery to phases of a corresponding motor,
a drive module, which supplies electric drive signals to transistors of the electronic power module, and
a monitoring unit, which supplies drive instructions to the drive module,
wherein the drive instructions define chopping ratios of the transistors of the electronic power module, and
wherein the drive module is powered by a connector that includes a relay capable of instantaneously interrupting a supply of power to the drive module, in order to stop the motor, without interrupting a supply of power to the monitoring unit.

29. A motor vehicle, comprising:
a plurality of electric motors;
a plurality of driving wheels, each of the driving wheels being equipped with a respective one of the motors; and
a device configured to control and jointly supply power to the motors,
wherein the device includes:
an electronic power module, which supplies power from a main battery to phases of the two motors,
a drive module, which supplies electric drive signals to transistors of the electronic power module, and
a monitoring unit, which supplies drive instructions to the drive module,
wherein the drive instructions define chopping ratios of the transistors of the electronic power module, and
wherein the drive module is powered by a connector that includes a relay capable of instantaneously interrupting a supply of power to the drive module, in order to stop the motors, without interrupting a supply of power to the monitoring unit.

30. A method of controlling and supplying power to a multi-phase electric motor powered by a main battery in order to obtain an emergency stop of the motor, the method comprising:
go on supplying power to a monitoring unit capable of defining chopping ratios of an electronic power module associated with the motor; while
interrupting a supply of power to a drive module, the drive module being controlled by the monitoring unit and being capable of supplying control signals to transistors of the electronic power module.
